(19) United States
(12) Patent Application Publication
(10) Pub. No.: US 2018/0201533 A1
(43) Pub. Date: Jul. 19, 2018

(54) Proppants Comprising Glass Material

(71) Applicant: BORAL IP HOLDINGS (AUSTRALIA) PTY LIMITED, North Sydney (AU)

(72) Inventors: Redmond Richard Lloyd, Wollongong, NSW (AU); Louise Margaret Keyte, Wollongong, NSW (AU)

(73) Assignee: BORAL IP HOLDINGS (AUSTRALIA) PTY LIMITED, North Sydney (AU)

(21) Appl. No.: 15/755,683

(22) PCT Filed: Aug. 28, 2015
(86) PCT No.: PCT/IB2015/001472

§ 371 Date: Feb. 27, 2018

(51) Int. Cl. C03B 19/10; E21B 43/267

(52) U.S. Cl. CPC C03B 19/1005; E21B 43/267

(57) ABSTRACT

Proppants and methods for their preparation are described herein. The proppants can be prepared by a process comprising (a) directing a molten glass material on to an atomizing apparatus to output the molten glass material in the form of atomized droplets, and (b) projecting the droplets of the molten glass material towards a receiver, wherein a substantial portion of the droplets at least partially solidifies in flight. In some embodiments, the molten glass material can include molten slag. The atomizing apparatus can be a spinning disc, for example a rotary atomizing disc. Methods for hydraulic fracturing of a well in a subterranean formation having a fracturing stress are also described herein.

FIELD OF THE DISCLOSURE

This disclosure relates generally to proppants, more particularly, to methods of making proppants from molten glass materials.

### BACKGROUND OF THE DISCLOSURE

In the process of acquiring oil and/or gas from a well, it is often necessary to stimulate the flow of hydrocarbons via hydraulic fracturing. Unless the pressure is maintained, however, the newly formed openings close, in order to hold the fracture open once the fracturing pressure is released, a propping agent (proppant) is mixed with the fluid and injected into the opening. With down well pressures often greater than 5000 pounds per square inch, the proppants must exhibit suitable strength, reliability and permeability. Typically, proppants are manufactured from materials such as kaolin and bauxite in a rotary kiln. The material, however, must be mined, grounded, pelletized, heated, and sized before use. Consequently, the manufacturing process requires high energy input and is therefore very expensive. There is a need for a low energy, cost effective process for producing proppants with desirable properties for resisting down well pressures. The compositions and methods described herein address these and other needs.

### SUMMARY OF THE DISCLOSURE

Proppants and methods for their preparation are described herein. The proppants (proppant particles) can be prepared by a process comprising (a) directing a molten glass material to an atomizing apparatus to output the molten glass material in the form of atomized droplets, and (b) projecting the droplets of the molten glass material towards a receiver, wherein a substantial portion of the droplets at least partially solidifies in flight. In some embodiments, the at least partially solidified droplets can have a solid fraction volume of from 20% to 80%. For example, the at least partially solidified droplets can have a solid fraction volume of front 20% to 50%.

The molten glass material can include molten slag, for example, blast furnace slag, steelmaking slag, copper furnace slag, ladle furnace slag, and nickel furnace slag. The molten glass material can include a material selected from aluminum oxide, boron oxide, potassium oxide, zirconium oxide, magnesium oxide, calcium oxide, titanium oxide, iron oxide, phosphorous oxide, manganese oxide, chromium oxide, calcium, silicon, aluminum, magnesium, manganese, titanium, sodium, potassium, lithium, sulfur, iron, and combinations thereof.

The proppants formed from the molten glass material can have an average diameter of 0.3 mm or greater. For example, the proppants can have an average diameter of from 0.3 mm 3 mm or from 0.3 mm to 1 mm. In some embodiments, the proppants can have a Krumbein sphericity and roundness of 0.5 or greater. For example, the proppants can have a Krumbein sphericity and roundness of 0.7 to 0.8.

Methods for of forming proppant particles from a molten glass material are also described herein. The method can include (a) directing the molten glass material on to an atomizing apparatus to output the molten glass material in the form of atomized droplets, (b) projecting the droplets of molten glass material towards a receiver, wherein a substantial portion of the droplets at least partially solidifying in flight, and (c) collecting the glass particulates. The atomizing apparatus can be a spinning disc, for example a rotary atomizing disc.

Methods for hydraulic fracturing of a well in a subterranean formation having a fracturing stress are also described herein. The method can include pumping a fracturing fluid comprising the proppants disclosed herein into the well at a pressure above the fracturing stress of the formation to carry the proppants in the fluid into the subterranean formation.

### DETAILED DESCRIPTION

Proppants, i.e., proppant particles, and methods for their preparation are described herein. In some embodiments, the proppants can be prepared from a molten glass material. In some embodiments, the glass material can be any material formed from an inorganic compound containing a metal, semi-metal, non-metal, or combinations thereof. In some embodiments, the glass material can comprise a natural glass material such as a meltable rock including basalt, granite, marble, andesite, syenite, or combinations thereof. In some examples, the molten glass material can be any conventional glass such as, for example, soda-lime glass, lead glass, or borosilicate glass.

In some embodiments, the molten glass material can be a by-product from the process of smelting an ore to purify metals, also known as slag. The slag can be from any metal refining vessel including blast furnace slag, iron furnace slag, steelmaking slag, copper furnace slag, ladle furnace slag, and nickel furnace slag.

In some embodiments, the molten glass material can comprise a material selected from an alkali metal of oxides thereof, such as lithium, sodium, potassium, rubidium, cesium, and francium; an alkaline metal or oxides thereof, such as calcium and magnesium; a transition metal or oxides thereof; such as iron, scandium, titanium, manganese, vanadium, chromium, manganese, cobalt, nickel, copper, zinc, yttrium, zirconium, niobium, molybdenum, ruthenium, rhodium, palladium, silver, cadmium, hafnium, tantalum, tungsten, platinum, gold, and mercury; other elements such as silicon, aluminum, sulfur; and combinations thereof. For example, the molten glass material can comprise aluminum oxide, silicon oxide, boron oxide, potassium oxide, zirconium oxide, magnesium oxide, calcium oxide, lithium oxide, phosphorous oxide, titanium oxide, iron oxide, manganese oxide, chromium oxide, or any combination thereof.

Materials other than these oxides can be present in the molten glass material in an amount of from 0.1% to 25% by weight, such as 0.1% to 10%, or 0.1% to 5% by weight.

The proppants prepared from the molten glass material can be spherical or irregularly shaped. In some embodiments, the proppants may be completely round or they may be not completely round. In some examples, the proppants can be spherical, oval, or any spheroidal shape. In some embodiments, the proppants can have a Krumbein shape factor, that is, a sphericity and roundness of 0.5 or greater. In some examples, the proppants can have a Krumbein sphericity and roundness from 0.5 to 1, such as 0.7 to 0.9 or 0.7 to 0.8, The Krumbein shape factor of the proppants can be determined using ISO 13503-2:2006 or API RP19C:2008.

The proppants described herein cart have any suitable size. In some embodiments, the proppants can have an average diameter of 0.3 mm or greater. For example, the proppants can have an average diameter of from 0.3 mm to 3 mm, such as from 0.3 mm to 2 mm, or 0.3 mm to 1 mm. In some embodiments, 80% or greater by number of the proppants can have an average particle diameter of 3 mm or less. For example, 80% or greater by number of the proppants can have an average particle diameter of 0.3 to 3 mm.

The proppants can be mechanically strong. For example, the proppants can have a crush strength of 1,000 psi or higher. In some embodiments, the proppants can have a crush strength of from 1,000 psi to 20,000 psi, 1,500 psi to 10,000 psi, or 3,000 psi to 10,000 psi. The proppants can have a density of 1.0 g/cm³or greater. For example, the proppants can have a density of from 1.0 g/cm³to 4.0 g/cm³, such as from 2.0 g/cm³ to 3.5 g/cm³ or from 2.5 g/cm³ to 3.0 g/cm³.

Methods for preparing proppants from molten glass materials are described herein. The proppants can be prepared from any one or more of the molten glass materials disclosed herein, In some examples, the proppants can be prepared from slag. Methods for preparing the proppants can include directing the molten glass material on to an atomizing apparatus to output the molten glass material in the form of atomized droplets. In some embodiments, the glass material may be provided as a solid, for example, a meltable rock. In some examples, the method can include heating the solid glass material to its molten state prior to directing the molten glass material on to the atomizing apparatus.

The molten glass material can be directed to the atomizing apparatus by any suitable means, such as via a conduit. In some examples, the molten glass material can be directed to the atomizing apparatus by a tube, pipe, channel, trough, or other form of conduit. The molten glass material may be discharged from the conduit by any suitable means known in the art. In some examples, the molten glass material may be discharged by a nozzle, spout, tap, or other means of controlling the delivery of the molten glass material to the atomizing apparatus. In some embodiments, the molten glass material may be discharged from the end of the conduit without any other means of controlling the delivery.

The molten glass material can be at an elevated temperature in the conduit, prior to contacting the atomizing apparatus. For example, the-molten glass material can be at an elevated temperature wherein the glass material is substantially molten. In some examples, the molten glass material can be at a temperature of from about 1200° C. to about 1600° C. In some embodiments, the temperature of the molten glass material in the conduit may be higher than the temperature at the time the material is received by the atomizing apparatus due to heat loss between the end of the conduit and the atomizing apparatus. It will be understood by those of skill in the art that the temperature at which the glass material is substantially molten is dependent on the nature of the glass material.

The flow rate (also referred to as a tapping rate) of the molten glass material from the conduit and on to the atomizing apparatus may vary. For example, the flow rate may depend on the design and operating conditions of other components used in the method, for example, the atomizing apparatus to output the molten glass material in the form of atomized droplets, and on the glass material being atomized. In some embodiments, the flow rate of the molten glass material from the conduit can be from 1 kg/min, for example in small plants or test rigs, to several tons/min, for example in an industrial scale plants.

The atomizing apparatus to output the molten glass material in the form of atomized droplets can be any suitable atomizing apparatus. In some embodiments, the atomizing apparatus can be a rotary spinning disc such as a rotary atomizer. Suitable rotary apparatus are described in WO2009/155667 to Xie et al.

The rotary atomizer, on contact with the molten glass material, forces the glass material outward where it is granulated. The rotating speed of the rotary apparatus can influence the diameter and shape of the molten glass droplets. It is believed that higher rotating speeds made the droplets smaller, more spherical, and uniform. The rotary apparatus can be operated at any suitable speed for forming any desirable atomized droplets from the molten glass material. In some embodiments, the speed of the rotary apparatus can be from 500 rpm to 20,000 rpm or 900 prm to 10,000 rpm (e.g., 900 rpm to 2500 rpm). In some examples, droplets with an average diameter of 5 mm or greater can be obtained at a rotating speed of less than 1500 rpm. In some examples, droplets with an average diameter of 2 mm or less can be obtained at a rotating speed of 1500 rpm or greater. The exit velocity of the droplet can also influence the droplet size and shape. The person skilled in the art would understand how to select the rotating speed of the rotary apparatus to obtain desired droplet size and shape.

The method for preparing proppants can include projecting the droplets of the molten glass material, for example, towards a receiver. In some embodiments, the atomizing apparatus projects the molten glass material towards the receiver. As the droplets projects towards the receiver, the droplets cool by releasing heat energy, such that a substantial portion of the droplets at least partially solidifies in flight. As used herein, “at least partially solidified” droplets. refers to particles of completely solidified glass material and/or particles having at least a solidified outer shell, and may also have a molten inner core. In some embodiments, the projected droplets can be blasted with a gas and/or a liquid, to recover the heat energy released from the molten glass material. In some embodiments, the droplets can be blasted with air, a reactant gas, and/or water. In some examples, the projected droplets can be blasted with air.

In some embodiments, the droplets may be projected towards a target surface where the droplets impact the target surface prior to the receiver. The target surface may be positioned at a distance and angle such that a substantial portion of the droplets have not become fully solidified prior to impact. Impact of the partially solidified droplets with the target surface may cause at least a portion of the partially solidified droplets to fracture and form fractured droplets. The fracturing of the partially solidified droplets may cause the solidified outer region to crack, break, rupture, or otherwise fracture and expose at least a portion of molten inner region to the exterior of the fractured droplets. The exposure of the molten inner region to the exterior may allow the fractured droplets to cool and solidify faster than the partially solidified droplets would have in the absence of fracturing on impact with the target surface.

The angle at which the target surface is disposed relative to the trajectory of the droplets may also be modified to control the force of the impact. WO 2009/155666 to Xie et al. discloses a granulator comprising a rotary atomizer for receiving a molten material and projecting droplets of the molten material there from; and an impact surface disposed within the trajectory of the droplets and upon which the droplets impact. The angle at which the target surface is disposed relative to the trajectory of the droplets may be 30 degrees to 75 degrees, measured in the radial direction of impact, in some embodiments, the angle at which the target surface is disposed relative to the trajectory may be frons 45 degrees to 60 degrees. The person skilled in the art would understand that whether the partially solidified droplets fracture upon impact with the target surface is a function of the velocity, the degree of solidification, the angle of impact, and the size of the at least partially solidified droplets.

The at least partially solidified droplets can have a solid fraction volume of 20% or greater prior to contacting the receiver. For example the at least partially solidified droplets can have a solid fraction volume of 30% or greater, 50% or greater, or 60% or greater, in some examples, the at least partially solidified droplets can have a solid fraction volume of from 20% to 80%, or from 20% to 60%. In some examples, the at least partially solidified droplets can have a solid fraction volume of up to 100%. However, the person skilled in the art would understand that the extent of the at least partial solidification of the droplets will depend on the droplet flight time, droplet temperature, droplet size, and/or velocity of the droplet. For example, it is understood that smaller droplets (for example, 2 mm or smaller) can reach a higher solid fraction compared to larger droplets (3 mm or greater), before contact with the receiver. In some examples, droplets 2 mm or smaller may have a solid fraction volume of 80% or greater. In some examples, droplets greater than 2 mm may have a solid fraction volume of less than 50%. The viscosity and surface tension of the droplets may also affect the solid fraction volume. In some embodiments, the partially solidified droplets can have a solidified outer region or shell and a molten inner region or core.

As discussed herein, the droplets can be projected towards a target surface where the droplets impact the target surface prior to the receiver. The droplets, on impact with the target surface, may fracture (into one or more smaller droplets) depending on their size and solid fraction volume. In some embodiments, droplets 3 mm or greater and having a solid fraction volume of 50% or less may fracture on impact with the target surface. In some embodiments, smaller droplets (2 mm or smaller) may reach a higher solid fraction volume before impact with the target surface and may not show much fracturing.

In some embodiments, droplets having a solid fraction of 50% or greater can be in an amount of 60% or greater. For example, droplets having a solid fraction of 50% or greater can be in an amount of 70% or greater, 80% or greater, 85% or greater, 90% or greater, 92% or greater, 94% or greater, 95% or greater, 96% or greater, 97% or greater, 98% or greater, 99% or greater, or 100%. The person skilled in the art would understand that the amount of droplets having a solid fraction of 50% or greater may depend on the droplet flight time, droplet temperature, droplet size, and/or velocity.

The at least partially solidified droplets can be any suitable size. The droplets can be substantially the same size as the proppants described herein, particularly where the droplets are not fractured as part of the process. In some embodiments, the partially solidified droplets can have an average diameter of 0.3 mm or greater. In some examples, the at least partially solidified droplets can have an average diameter from 0.3 mm to 3 mm, such as from 0.3 mm to 2 mm, 0.3 mm to 1 mm, 0.3 mm to 0.9 mm, or 0.3 mm to 0:85 mm. In some embodiments, 75% or greater, 80% or greater, 85% or greater, 90% or greater, or 95% or greater by number of the droplets can have an average particle diameter of 3 mm or less. For example, 75% or greater, 80% or greater, 85% or greater, 90% or greater, or 95% or greater by number of the droplets can have an average particle diameter of 0.3 to 3 mm.

The droplet flight time (time spent between the atomizing apparatus and the receiver) may vary. The droplet flight time can influence the amount and the solid fraction volume of the partially solidified droplets. It is believed that longer flight times increase the solid fraction volume of the partially solidified droplets. However, a person skilled in the art would understand that the nature of the molten glass material, the temperature of the glass material, and the droplet size will influence the solid fraction volume. In some embodiments, the droplet flight time between the atomizing apparatus and the receiver can be 5 seconds or less. For example, the droplet flight time between the rotary atomizer and the receiver can be 1 second or less; 0.75 seconds or less, 0.5 seconds or less, or 0.3 seconds or less.

As discussed herein, the at least partially solidified droplets can be projected to a receiver. All or substantially ail of the projected droplets of Molten glass material may follow the trajectory towards the receiver. The receiver is positioned a distance away from the atomizing apparatus, which can influence the amount and the solid fraction volume of the partially solidified droplets. It is believed that longer distances increase the solid fraction volume of the partially solidified droplets. However, a person skilled in the art would understand that the nature of the molten glass material, the temperature of the glass material, and the droplet size will influence the solid fraction volume. The receiver cart he positioned at arty suitable distance away from the atomizing apparatus such that a substantial portion of the droplets are at least partially solidified prior to contact with the receiver. A person skilled in the art. would understand that the distance between the atomizing apparatus and the receiver may be determined by the desired solid fraction volume of the partially solidified droplets. Any receiver known in the art may he used for the collection of the at least partially solidified droplets. In some examples, the receiver can be an opening of any dimensions positioned such that the at least partially solidified droplets are collected from flight.

The proppants described herein can be used to prop open subterranean formations. In some embodiments, the proppants can he suspended in a liquid phase or other medium. to facilitate transporting the proppant down a well to a subterranean formation and placed such as to allow the flow of hydrocarbons, natural gas, or other raw materials out of the formation. In some embodiments, the present disclosure relates to a fracturing fluid containing one or more of the proppants described herein. In some embodiments, the present disclosure relates to a well site or subterranean formation containing one or more of the proppants described herein. The proppants can withstand a broad range of temperatures from 200° C. to 1500° C.

The medium for pumping the proppant can be any desired medium capable of transporting the proppants to its desired location. For example, the medium can be an aqueous-based medium or an oil-based medium. In some examples, the medium can be selected from water, brine solutions, aqueous polymer solutions, aqueous surfactant solutions, viscous emulsions of water and oil, gelled oils, gelled aqueous fluids, foams, gases, or combinations thereof.

Methods for hydraulic fracturing of a well in a subterranean formation having a fracturing stress are also described herein. The method can include introducing a fracturing fluid comprising the proppants described herein into the well such as by pumping or other means of introduction known in the art. The proppants can be introduced at a pressure above the fracturing stress of the formation to carry the proppant particles in the fluid into the subterranean formation.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein. is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

1. Proppant particles prepared by a process comprising:
(a) directing molten glass material to an atomizing apparatus to output the molten glass material in the form of atomized droplets,
(b) projecting the droplets of the molten glass material, wherein a substantial portion of the droplets at least partially solidifies in flight.

2. The proppant particles according to claim 1, wherein the molten glass material includes molten slag.

3. The proppant particles according to claim 1, wherein the proppant particles include calcium, silicon, aluminum, magnesium, manganese, titanium, sodium, potassium, lithium, sulfur, iron, or combinations thereof.

4. The proppant particles according to claim 1, wherein the molten glass material comprises a material selected from aluminum oxide, boron oxide, silicon oxide, potassium oxide, zirconium oxide, magnesium oxide, calcium oxide, titanium oxide, iron oxide, phosphorous oxide, manganese oxide, chromium oxide, and combinations thereof.

5. The proppant particles according to claim 1, wherein the proppant particles have a Krumbein sphericity and roundness of 0.5 or greater.

6. The proppant particles according to claim 5, wherein the proppant particles have a Krumbein sphericity and roundness of 0.7 to 0.8.

7. The proppant particles according to claim 6, wherein the proppant particles have an average diameter of from 0.3 mm to 3 mm.

8. The proppant particles according to claim 7, wherein the proppant particles have an average diameter of from 0.3 mm to 1 mm.

9. The proppant particles according to claim 1, wherein the at least partially solidified droplets have a solid fraction volume of from 20% to 80%.

10. The proppant particles according to claim 9, wherein the at least partially solidified droplets have a solid fraction volume of from 20% to 50%.

11. The proppant particles according to claim 1, wherein the proppant particles have a bulk density of from 1.0 to 4.0 g/cm³.

12. The proppant particles according to claim 1, wherein the proppant particles have a bulk density of from 2.0 to 3.5 g/cm³.

13. The proppant particles according to claim 1, wherein the proppant particles have a bulk density of from 2.5 to 3.0 g/cm³.

14. A method for of forming proppant particles from molten glass material, the method comprising:
(a) directing a molten glass material to an atomizing apparatus to output the molten glass material in the form of atomized droplets,
(b) projecting the droplets of molten glass material, a substantial portion of the droplets at least partially solidifying in flight, and
(c) collecting the at least partially solidified droplets.

15. The method according to claim 14, wherein the atomizing apparatus is a rotary atomizing disc.

16. A method for hydraulic fracturing of a well in a subterranean formation having a fracturing stress, comprising pumping a fracturing fluid comprising the proppant particles of claim 1 into the well at a pressure above the fracturing stress of the formation to carry the proppant particles in the fluid into the subterranean formation.
